(19) United States
(12) Patent Application Publication
(10) Pub. No.: US 2008/0187796 A1
(43) Pub. Date: Aug. 7, 2008

(54) Integrated Load Following Anode Gas Pump and Cathode Gas Compressor for a Fuel Cell Power System

(75) Inventors: Joseph D. Rainville, Caledonia, NY (US); James S. Siepierski, Williamsville, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM Global Technology Operations, Inc., Detroit, MI (US)

(21) Appl. No.: 11/669,994

(22) Filed: Feb. 1, 2007

(51) Int. Cl. H01M 8/04

(52) U.S. Cl. 429/17

(57) ABSTRACT

A fuel cell system that employs an air compressor for providing cathode inlet air to the cathode side of a fuel cell stack and an anode gas recirculation blower that recirculates anode exhaust gas back to the anode side of the fuel cell stack. The fuel cell system also employs an electric motor having a drive shaft that is coupled to both the air compressor and the anode recirculation blower so that the compressor and blower are driven by a common motor. The compressor and blower are designed so that as the load on the stack increases and decreases, the motor will increase and decrease the speed of the air compressor and the anode recirculation blower in combination to provide the proper cathode and anode reactant gas flow to the stack for the load.

### BACKGROUND OF THE INVENTION

1. Field of the Invention

This invention relates generally to a fuel cell system and, more particularly, to a fuel cell system that employs an integrated cathode inlet air compressor and anode recirculation blower.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

It is desirable that the distribution of hydrogen within the anode flow channels in the fuel cell stack be substantially constant for proper fuel cell stack operation. Therefore, it is known in the art to input more hydrogen into the fuel cell stack than is necessary for a certain output load of the stack so that the anode gas distribution is proper. However, because of this requirement, not all of the hydrogen is consumed by the stack where the amount of hydrogen in the anode exhaust gas is significant, which would lead to low system efficiency if that hydrogen were discarded. Further, hydrogen gas in a sufficient quantity discharged to the environment could cause problems because of the reactive nature of hydrogen. Therefore, it is known in the art to recirculate the anode exhaust gas back to the anode input to reuse the discarded hydrogen. Some fuel cell systems employ an anode gas recirculation blower for recirculating the anode exhaust gas back to the anode inlet.

### SUMMARY OF THE INVENTION

In accordance with the teachings of the present invention, a fuel cell system is disclosed that employs an air compressor for providing cathode inlet air to the cathode side of a fuel cell stack and an anode gas recirculation blower that recirculates anode exhaust gas back to the anode side of the fuel cell stack. The fuel cell system also employs an electric motor having a drive shaft that is coupled to both the air compressor and the anode recirculation blower so that the compressor and blower are driven by a common motor. The compressor and blower are designed so that as the load on the stack increases and decreases, the motor will increase and decrease the speed of the air compressor and the anode recirculation blower in combination to provide the proper cathode and anode reactant gas flow to the stack for the load.

Additional features of the present invention will become apparent from the following description and appended claims, taken in conjunction with the accompanying drawings.

### BRIEF DESCRIPTION OF THE DRAWINGS

FIG. 1 is a schematic block diagram of a fuel cell system employing an integrated air compressor and anode recirculation blower, according to an embodiment of the present invention; and

FIG. 2 is a schematic block diagram of a fuel cell system employing an integrated air compressor and anode recirculation blower, according to another embodiment of the present invention.

### DETAILED DESCRIPTION OF THE EMBODIMENTS

The following discussion of the embodiments of the invention directed to a fuel cell system that employs an integrated air compressor and anode recirculation blower is merely exemplary in nature, and is in no way intended to limit the invention or its applications or uses.

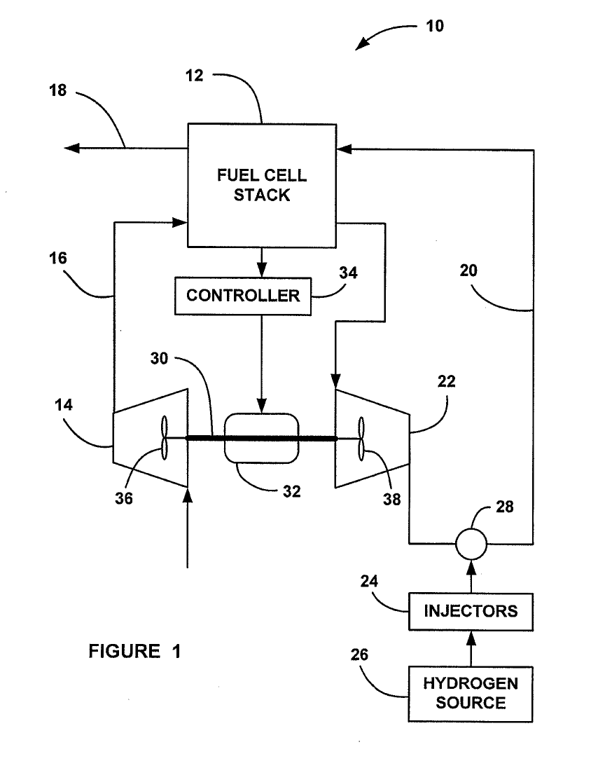

FIG. 1 is a schematic block diagram of a fuel cell system 10 including a fuel cell stack 12 having an anode side and a cathode side. An air compressor 14, including an impeller 36, provides cathode inlet air on cathode inlet line 16 to the cathode side of the fuel cell stack 12 and cathode exhaust gas is output from the cathode side of the fuel cell stack 12 on cathode exhaust line 18. The fuel cell system 10 also includes an anode recirculation loop 20 that recirculates anode exhaust gas from the anode side of the fuel cell stack 12 to the anode inlet of the fuel cell stack 12. An anode recirculation blower 22, including an impeller 38, drives the recirculated anode exhaust gas through the loop 20. The fuel cell system 10 includes a bank of injectors 24 that inject an anode reactant gas from a hydrogen source 26 to a mixing junction 28 so that fresh hydrogen is mixed with the anode recirculation gas in the loop 20 to replenish the used hydrogen. The hydrogen source 26 can be any suitable hydrogen source for a fuel cell system, and may provide nearly pure hydrogen to the fuel cell stack 12 or a hydrogen reformate gas.

The anode recirculation loop 20 would include an anode exhaust gas bleed valve (not shown) for periodically bleeding the anode recirculation gas to remove nitrogen therefrom that effects stack stability, as would be well understood to those skilled in the art. The bleed valve would typically be upstream from the mixing junction 28. As the load on the stack 12 increases and decreases, the amount of air provided to the cathode side of the stack 12 from the compressor 14 and the flow of hydrogen to the anode side of the fuel cell stack 12 from the hydrogen source 26 goes up and down in proportion thereto to provide the desired stack power.

The air compressor 14 and the anode recirculation blower 22 could be the same type or different type of devices, such as a turbo-machine, a centrifugal machine, a mixed flow machine, a radial machine, etc. However, the impellers 36 and 38 of the compressor 14 and the anode recirculation blower 22, respectively, would be different in that the compressor 14 is intended to provide pressure to move the cathode air through the fuel cell stack 12, and the anode recirculation blower 22 typically is used to provide gas flow, and not add significant pressure. Further, the anode exhaust gas from the fuel cell stack 12 would be significantly wet where the compressor air would be dry. Therefore, the anode recirculation blower 22 would need to be designed to address the moisture in the anode recirculation gas.

According to the invention, a common shaft 30 coupled to an electric motor 32 drives the air compressor 14 and the anode recirculation blower 22. The electric motor 26 can be any machine suitable for the purposes described herein, and could use one of several types of bearing technology including air, magnetics, oil film, roller bearings, etc. depending on the speed ranges required. A controller 34 is provided that receives a power output signal from fuel cell stack 12, and controls the speed of the motor 32 in response thereto. Coupling of these types of driven machines in this manner requires one of the machines to be a master machine and the other machine to be a slave machine. In this configuration, it would probably be necessary to make the air compressor 14 the master machine.

The air compressor 14 and the anode recirculation blower 22 would be designed and calibrated so that the proportional amount of air and hydrogen applied to the fuel cell stack 12 is regulated for the same speed of the shaft 30 as the load on the stack 12 increases and decreases. The impellers 36 and 38 in the air compressor 14 and the anode recirculation blower 22, respectively, would need to be properly geared so that the impeller spin was proper for the same speed of the shaft 30, or in the case of direct drive, the anode impeller 38 is designed to operate within the RPM range of the compressor impeller 36 and the motor 32. Further, the speed of the motor 32 would need to satisfy the operation of both the air compressor 14 and the anode recirculation blower 22.

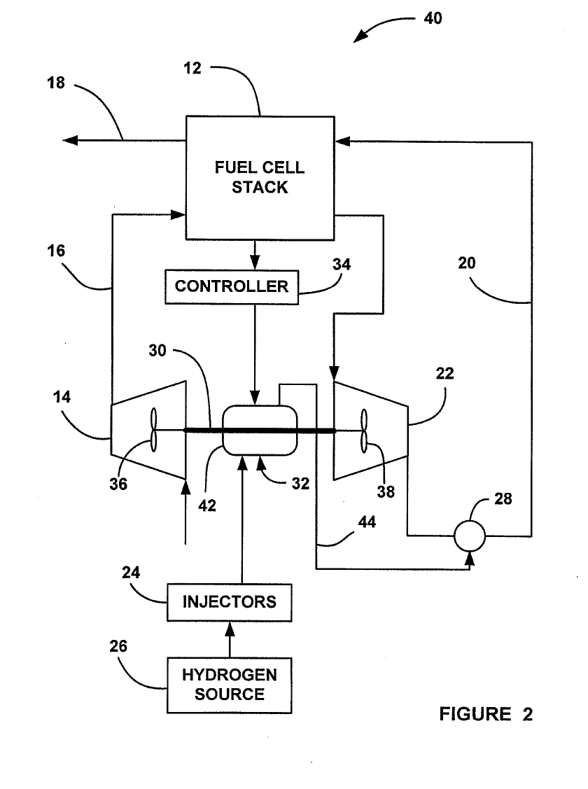

FIG. 2 is a schematic block diagram of a fuel cell system 40 similar to the fuel cell system 10, where like elements are identified by the same reference numerals. In this embodiment, the fresh hydrogen from the hydrogen source 26 is first directed through a sealed housing 42 of the motor 32 to provide motor cooling and reduce windage losses of the motor 32. The fresh hydrogen is then output from the motor housing 42 on line 44 and sent to the mixing junction 28. The mixing junction 28 could be located internal to the anode blower 22, or externally as shown in FIG. 2. Therefore, the fresh hydrogen can be used to cool the motor 32 before it is consumed by the stack 12.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a fuel cell stack including a cathode side and an anode side, said cathode side receiving an airflow and said anode side receiving an anode reactant gas flow;
an air compressor providing the airflow to the cathode side of the fuel cell stack;
an anode recirculation loop for recirculating anode exhaust gas from the stack back to the anode side of the fuel cell stack;
an anode recirculation blower that causes the anode exhaust gas to flow back to the anode side of the fuel cell stack; and
an electric motor including a motor shaft, said motor shaft being coupled to both the air compressor and the anode recirculation blower so that the same motor drives both the air compressor and the anode recirculation blower.

2. The system according to claim 1 further comprising a hydrogen source that provides fresh hydrogen to the anode recirculation loop to be mixed with the recirculated anode exhaust gas.

3. The system according to claim 2 wherein the fresh hydrogen is first directed through a motor housing enclosing the electric motor to cool the electric motor before it is sent to the anode recirculation loop.

4. The system according to claim 1 wherein the compressor and the anode recirculation blower include impellers that are designed and calibrated to provide the desired airflow pressure and recirculation gas flow for a common shaft speed.

5. The system according to claim 1 wherein the air compressor and the anode recirculation blower are centrifugal devices.

6. The system according to claim 1 wherein the air compressor and the anode recirculation blower are mixed flow devices.

7. The system according to claim 1 wherein the air compressor and the recirculation blower are radial devices.

8. The system according to claim 1 wherein the air compressor is a master machine and the anode recirculation blower is a slave machine.

9. A fuel cell system comprising an integrated compressor and anode recirculation blower driven by a common motor.

10. The system according to claim 9 wherein the air compressor and the anode recirculation blower are centrifugal devices.

11. The system according to claim 9 wherein the air compressor and the anode recirculation blower are mixed flow devices.

12. The system according to claim 9 wherein the air compressor and the recirculation blower are radial devices.

13. The system according to claim 9 wherein the air compressor is a master machine and the anode recirculation blower is a slave machine.

14. A fuel cell system comprising:
a fuel cell stack including a cathode side and an anode side, said cathode side receiving an airflow and said anode side receiving an anode reactant gas flow;
an air compressor providing the airflow to the cathode side of the fuel cell stack;
an anode recirculation loop for recirculating anode exhaust gas from the stack back to the anode side of the fuel cell stack;
a hydrogen source that provides fresh hydrogen to the anode recirculation loop to be mixed with the recirculated anode exhaust gas;
an anode recirculation blower that causes the anode exhaust gas to flow back to the anode side of the fuel cell stack; and
an electric motor including a motor shaft, said motor shaft being coupled to both the air compressor and the anode recirculation blower so that the same motor drives both the air compressor and the anode recirculation blower, wherein the air compressor is a master machine and the anode recirculation blower is a slave machine, and wherein the compressor and the anode recirculation blower include impellers that are designed and calibrated to provide the desired airflow pressure and recirculation gas flow for a common shaft speed.

15. The system according to claim 14 wherein the fresh hydrogen is first directed through a motor housing enclosing the electric motor to cool the electric motor before it is sent to the anode recirculation loop.
